(19) United States
(12) Patent Application Publication
(10) Pub. No.: US 2023/0278224 A1
(43) Pub. Date: Sep. 7, 2023

(54) TOOL CALIBRATION FOR MANUFACTURING ROBOTS

(71) Applicant: Path Robotics, Inc., Columbus, OH (US)

(72) Inventors: Colin BUNKER, Columbus, OH (US); Alexander James LONSBERRY, Gahanna, OH (US); Andrew Gordon LONSBERRY, Columbus, OH (US); Nima Ajam GARD, Columbus, OH (US); Milad KHALEDYAN, San Jose, CA (US); Carlos Fabian BENITEZ-QUIROZ, Columbus, OH (US)

(21) Appl. No.: 18/179,796

(22) Filed: Mar. 7, 2023

Related U.S. Application Data
(60) Provisional application No. 63/317,335, filed on Mar. 7, 2022.

(51) Int. Cl. B25J 9/16; B25J 11/00

(52) U.S. Cl. CPC B25J 9/1692; B25J 9/1697; B25J 11/005

(57) ABSTRACT

A method for calibrating a tool center point (TCP) of a robotic welding system. The method includes receiving a plurality of images captured from a plurality of image sensors of the robotic welding system, the plurality of images containing at least a portion of a protrusion extending from a tip of a weldhead of the robotic welding system, and identifying by a controller of the robotic welding system the protrusion extending from the weldhead in the plurality of images. The method additionally includes defining by the controller a longitudinal axis of the protrusion based on the protrusion identified in the plurality of images, and identifying by the controller a location in three-dimensional (3D) space of the weldhead based on the protrusion identified in the plurality of images and the defined longitudinal axis of the protrusion.

### CROSS-REFERENCE TO RELATED APPLICATIONS

This application claims benefit of U.S. provisional patent application Ser. No. 63/317,335 filed Mar. 7, 2022, entitled “Tool Calibration for Manufacturing Robots,” the entire contents of which are incorporated herein by reference for all purposes.

### STATEMENT REGARDING FEDERALLY SPONSORED RESEARCH OR DEVELOPMENT

Not applicable.

### BACKGROUND

Robotic welding systems generally include one or more robots each having an instrument or tool such as, for example, a welding tool connected thereto and which operates or “works” on a part or workpiece secured within the robotic welding system. These robotic welding systems provide an avenue through which robotics may be leveraged in manufacturing or fabrication processes. It may be understood that parts operated on by the robot(s) of robotic welding systems may vary significantly in shape, size, materials, etc. The robotic welding system may also include one or more sensors for monitoring the part and/or tool attached to the robot(s), and a control system or controller which controls the operation of the robot(s) and/or tool based on feedback received from the one or more sensors of the robotic welding system.

### BRIEF SUMMARY OF THE DISCLOSURE

A method for calibrating a tool center point (TCP) of a robotic welding system comprises (a) receiving a plurality of images captured from a plurality of image sensors of the robotic welding system, the plurality of images containing at least a portion of a protrusion extending from a tip of a weldhead of the robotic welding system, (b) identifying by a controller of the robotic welding system the protrusion extending from the weldhead in the plurality of images, (c) defining by the controller a longitudinal axis of the protrusion based on the protrusion identified in the plurality of images, and (d) identifying by the controller a location in three-dimensional (3D) space of the weldhead based on the protrusion identified in the plurality of images and the defined longitudinal axis of the protrusion. In some embodiments, the plurality of image sensors comprises a pair of cameras arranged stereoscopically in relation to the weldhead. In some embodiments, (c) comprises identifying a trajectory in 3D space of the longitudinal axis of the protrusion. In certain embodiments, (b) comprises annotating at least one of the plurality of images to indicate a base of the protrusion and a tip of the protrusion located opposite the base of the protrusion identified in the plurality of images. In some embodiments, (c) comprises (c1) defining a first plane in a first image of the plurality of plurality of images based on the annotated base of the protrusion, (c2) defining a second plane in a second image of the plurality of images based on the annotated tip of the protrusion, and (c3) intersecting the first plane with the second plane to define the longitudinal axis of the protrusion. In some embodiments, (d) comprises identifying the location in 3D space of the weldhead based on a first projection of the protrusion captured in a first image of the plurality of images, a second projection of the protrusion captured in a second image of the plurality of images that is different from the first image, and on a known length extending between a base of the protrusion and a tip of the protrusion. In certain embodiments, (d) comprises (d1) triangulating a location in 3D space of a tip of the protrusion based on a first projection of a tip of the protrusion captured in a first image of the plurality of images and a second projection of the tip of the protrusion captured in a second image of the plurality of images that is different from the first image, and (d2) identifying the location of a tip of the weldhead based on the location in 3D space of the tip of the protrusion and on a known length extending between a base of the protrusion and a tip of the protrusion. In some embodiments, (d) comprises identifying a pose in 3D space of the weldhead. In some embodiments, the plurality of image sensors comprises at least a portion of a local sensor unit or a global sensor unit of the robotic welding system.

An embodiment of a robotic welding system for welding a part comprises a fixture for holding the part to be welded, a robot extending between a base and a terminal end, a weldhead coupled to the terminal end of the robot, wherein the weldhead receives a protrusion, a sensor unit comprising a plurality of image sensors arranged whereby at least a portion of the weldhead is within a field of view of each of the plurality of image sensors; and a controller in signal communication with the sensor unit, wherein the controller is configured to receive a plurality of images captured from a plurality of image sensors of the robotic welding system, the plurality of images containing at least a portion of a protrusion extending from a tip of a weldhead of the robotic welding system; identify the protrusion extending from the weldhead in the plurality of images; define a longitudinal axis of the protrusion based on the protrusion identified in the plurality of images, and identify a location in 3D space of the weldhead based on the protrusion identified in the plurality of images and the defined longitudinal axis of the protrusion. In some embodiments, the controller is configured to annotate at least one of the plurality of images to indicate a base of the protrusion and a tip of the protrusion located opposite the base of the protrusion identified in the plurality of images. In some embodiments, the controller is configured to define a first plane in a first image of the plurality of plurality of images based on the annotated base of the protrusion, define a second plane in a second image of the plurality of images based on the annotated tip of the protrusion, and intersect the first plane with the second plane to define the longitudinal axis of the protrusion. In certain embodiments, the controller is configured to identify the location in 3D space of the weldhead based on a first projection of the protrusion captured in a first image of the plurality of images, a second projection of the protrusion captured in a second image of the plurality of images that is different from the first image, and on a known length extending between a base of the protrusion and a tip of the protrusion. In certain embodiments, the controller is configured to triangulate a location in 3D space of a tip of the protrusion based on a first projection of a tip of the protrusion captured in a first image of the plurality of images and a second projection of the tip of the protrusion captured in a second image of the plurality of images that is different from the first image, and identify the location of a tip of the weldhead based on the location in 3D space of the tip of the protrusion and on a known length extending between a base of the protrusion and a tip of the protrusion. In some embodiments, the plurality of image sensors comprises a pair of cameras arranged stereoscopically in relation to the weldhead. In some embodiments, the controller is configured to identify a pose in 3D space of the weldhead based on the protrusion identified in the plurality of images and the defined longitudinal axis of the protrusion. In certain embodiments, the protrusion comprises a welding wire.

An embodiment of a system for calibrating a tool center point (TCP) of a robotic welding system comprises a processor, a non-transitory memory, and an application stored in the non-transitory memory that, when executed by the processor receives a plurality of images captured from a plurality of image sensors of the robotic welding system, the plurality of images containing at least a portion of a protrusion extending from a tip of a weldhead of the robotic welding system, identifies the protrusion extending from the weldhead in the plurality of images, defines a longitudinal axis of the protrusion based on the protrusion identified in the plurality of images, and identifies a location in 3D space of the weldhead based on the protrusion identified in the plurality of images and the defined longitudinal axis of the protrusion. In some embodiments, the application, when executed by the processor annotates at least one of the plurality of images to indicate a base of the protrusion and a tip of the protrusion located opposite the base of the protrusion identified in the plurality of images. In some embodiments, the application, when executed by the processor defines a first plane in a first image of the plurality of plurality of images based on the annotated base of the protrusion, defines a second plane in a second image of the plurality of images based on the annotated tip of the protrusion, and intersects the first plane with the second plane to define the longitudinal axis of the protrusion. In certain embodiments, the application, when executed by the processor triangulates a location in 3D space of a tip of the protrusion based on a first projection of a tip of the protrusion captured in a first image of the plurality of images and a second projection of the tip of the protrusion captured in a second image of the plurality of images that is different from the first image, and identifies the location of a tip of the weldhead based on the location in 3D space of the tip of the protrusion and on a known length extending between a base of the protrusion and a tip of the protrusion. In certain embodiments, the application, when executed by the processor identifies a location in 3D space of the weldhead based on the protrusion identified in the plurality of images and the defined longitudinal axis of the protrusion.

### BRIEF DESCRIPTION OF THE DRAWINGS

For a detailed description of various exemplary embodiments, reference will now be made to the accompanying drawings in which:

FIG. 1 is a block diagram of an embodiment of a robotic welding system in accordance with principles disclosed herein;

FIG. 2 is a front view of another embodiment of a robotic welding system in accordance with principles disclosed herein;

FIG. 3 is a front view of an embodiment of a local sensor unit of the robotic welding system of FIG. 2 in accordance with principles disclosed herein

FIG. 4 is a flowchart of an embodiment of a method for calibrating the tool center point (TCP) of a robotic welding;

FIGS. 5-9 are images captured by image sensors of a tool of the robotic welding system of FIG. 2 in accordance with principles disclosed herein; and

FIG. 10 is an exemplary diagram of a technique for determining a pose of a tool of the robotic welding system of FIG. 2 in accordance with principles disclosed herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form, and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

As previously described, robotic welding systems may be utilized to leverage robotics in different manufacturing and fabrication processes and may generally include one or more robots, a fixture for positioning a part operated on by the robot(s), one or more sensors, and a controller for controlling the operation of the robot(s). The sensors of the robotic welding system may determine a location of a tool (e.g., a weldhead) coupled to the robot(s) relative to the robot, such as a frame of the robot. For example, the sensors of the robotic welding system may determine a location of a tool coupled to a robot relative to a frame of the robot, where the frame of the robot may be sourced from or comprise a kinematic model of the robot. Particularly, the sensors may determine a location of a tool center point (TCP) relative to a frame of the robot where the TCP may be located within or along a tool coupled to the robot, such as within a nozzle of a weldhead coupled to the robot.

In at least some embodiments, sensors of the robotic welding system determine a pose of a tool (e.g., a weldhead) coupled to the robot(s) in three-dimensional (3D) space. As another example, the sensors of the robotic welding system may determine a pose of a tool coupled to a robot relative to a frame of the robot, where the frame of the robot may be sourced from or comprise a kinematic model of the robot. As used herein, the term “pose” as used herein is defined as meaning the position and orientation of a feature (e.g., a tool of a robot) in three-dimensional (3D) space. Thus, an object's pose in 3D space incorporates the object's location in 3D space along with the object's orientation in 3D space with respect to a reference frame. In some instances, the position component of the pose of the tool in 3D space may be expressed in (X, Y, Z) coordinates while the orientation component of the pose of the tool in 3D space may be expressed using Euler angles.

Particularly, it is critical for the performance of the robotic welding system that the controller of the robotic welding system, based on data provided to the controller by the sensors of the system, be able to accurately position and orient the tool coupled to the robot with respect to the part in three-dimensional (3D) space. For instance, the tool may comprise a weldhead which must be accurately positioned and guided along a predefined trajectory along a seam of the part to be welded by the weldhead in order to successfully weld the part. In order to accurately control the pose of the tool in 3D space, the pose of the tool in 3D space is calibrated prior to the operation of the robotic welding system. Particularly, the robotic welding system may be calibrated by an operator thereof to accurately and precisely identify the active point of the tool (sometimes referred to as the TCP of the tool) in 3D space. The calibration of the robotic welding system may assist in bridging the gap between the mathematical or kinematic models of the robot(s) of the robotic welding system used by the controller to control the robot(s) and the real-world performance of the robot(s) which may depart in at least some ways from the performance of the robot(s) predicted by the mathematical models.

Conventionally, robotic welding systems are calibrated to identify the pose of the TCP in 3D space manually by having a robot of the system brush the TCP against a fixed point (e.g., the tip of a fixed member) in the operating environment having a known location in 3D space. This process may be repeated from different angles in order to complete the calibration of the robotic welding system such that the TCP's pose in 3D space may be calculated. Given that the tool must be repeatedly moved through space in order to identify the pose of the TCP in 3D space, this conventional technique for calibrating the robotic welding system is relatively time consuming and also prone to operator error given that an operator of the robotic welding system must guide the performance of the manual calibration process, thus making the successful performance of this manual calibration process contingent on the skill of the given operator.

Accordingly, embodiments of robotic welding systems are described herein which provide for the automated calibration of the robotic welding system whereby the pose of the TCP of the robotic welding system in 3D space may be accurately and precisely identified without the need of an operator for guiding the performance of the calibration process. Particularly, embodiments of robotic welding systems described herein include a controller in signal communication with a sensor unit of the robotic welding system and configured to receive a plurality of images captured from a plurality of image sensors of the robotic welding system, the plurality of images containing at least a portion of a protrusion extending from a tip of a weldhead of the robotic welding system. Thus, the controller may conveniently leverage the sensors of the robotic welding system to assist in performing the TCP calibration rather than an operator of the robotic welding system instructing the robot thereof to brush the TCP against a fixed object having a known position in 3D space, thereby automating the TCP calibration process while eliminating the opportunity for potential operator error in performing the TCP calibration process. Particularly, in embodiments disclosed herein, the controller may use the data provided by the image sensors of the robotic welding system to identify a protrusion extending from the tool in the plurality of images captured by the plurality of image sensors. Additionally, the controller may define a longitudinal axis of the protrusion based on the protrusion identified in the plurality of images, and identify a pose in 3D space of the tool based on the protrusion identified in the plurality of images and the defined longitudinal axis of the protrusion.

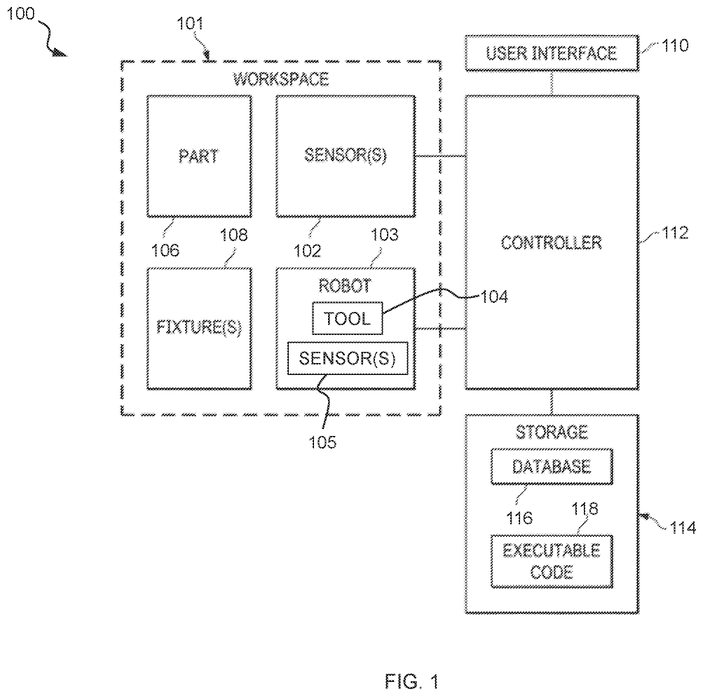

Referring now to FIG. 1, an embodiment of a robotic welding system 100 is shown. In this exemplary embodiment, robotic welding system 100 generally includes a manufacturing workspace 101, a user interface (UI) 110, a controller 112, and storage 114. It may be understood that robotic welding system 100 may include other components or subsystems not expressly described herein. Manufacturing workspace 101 is an area or enclosure within which a robot, such as a robotic arm, operates on one or more workpieces or parts that are positioned on, coupled to, or otherwise supported by a platform or positioner. In some embodiments, workspace 101 comprises any suitable welding area designed with appropriate safety measures for welding. For example, workspace 101 may comprise a welding area located in a workshop, job shop, manufacturing plant, fabrication shop, and/or the like.

In this exemplary embodiment, the manufacturing workspace 101 (or, more generally, workspace 101) of robotic welding system 100 includes sensors 102, a robot 103 that is configured to perform welding-type procedures such as welding, brazing, and bonding, and the like, a part 106 to be welded (e.g., a part having a seam), and a fixture 108. The fixture 108 of workspace 101 may hold, position, and/or manipulate the part 106 and may be, for example, clamps, platforms, positioners, or other types of fixtures. Additionally, fixture 108 may be configured to securely hold the part 106. In some embodiments, fixture 108 is adjustable, either manually by a user or automatically by a motor. For instance, the fixture 108 may dynamically adjust its position, orientation, and/or other physical configuration prior to or during a welding process.

In this exemplary embodiment, robot 103 of robotic welding system 100 includes a tool 104 and one or more sensors 105. For instance, one or more sensors 105 may be positioned on an arm (e.g., on a weldhead attached to the arm) of the robot 103. In another example, one or more sensors 105 may be positioned on a movable, non-welding robot arm (which may be different from the robot 103). In yet another example, one of the one or more sensors 105 may be positioned on the arm of the robot 103 and another one of the one or more sensors 105 may be positioned on a movable equipment in the workspace. In yet another example, one of the one or more sensors 105 may be positioned on the arm of the robot 103 and another one of the one or more sensors 105 may be positioned on a movable, non-welding robot arm. In some embodiments, the one or more sensors may be positioned to capture information regarding the tool 104 of the robot 103 such as the global position of the tool 104 and/or the position of the tool 104 relative to the position of the one or more sensors 105. The robot 103 may interact or perform work on the part 106 using the tool 104 which, in some embodiments, may comprise a weldhead.

The sensors 102 and 105 of robotic welding system 100 are configured to capture information associated with the workspace 101. In some embodiments, sensors 102 and 105 comprise image sensors configured to capture visual information (e.g., two-dimensional (2D) images) pertaining to the workspace 101. For instance, the sensors 102 and 105 may include cameras (including cameras incorporating other sensors such as built-in lasers), scanners (e.g., laser scanners), etc. The sensors 102 and 105 may include sensors such as Light Detection and Ranging (LiDAR) sensors. Alternatively or in addition, the sensors 102 and 105 may comprise audio sensors configured to emit and/or capture sound, such as Sound Navigation and Ranging (SONAR) devices. Alternatively or in addition, the sensors 102 and 105 may comprise electromagnetic sensors configured to emit and/or capture electromagnetic (EM) waves, such as Radio Detection and Ranging (RADAR) devices.

Through visual, audio, electromagnetic, and/or other sensing technologies, the sensors 102 and 105 of robotic welding system 100 may collect information about physical structures in the workspace 101. In examples, the sensors 102 and/or 105 collect static information (e.g., stationary structures in the workspace 101), and in other examples, the sensors 102 and/or 105 collect dynamic information (e.g., moving structures in the workspace 101), and in still other examples, the sensors 102 and/or 105 collect a combination of static and dynamic information. The sensors 102 and/or 105 may collect any suitable combination of any and all such information about the physical structures in the workspace 101 and may provide such information to other components (e.g., the controller 112) to generate a three-dimensional (3D) representation of the physical structures in the workspace 101. As described above, the sensors 102 and 105 may capture and communicate any of a variety of information types, but this description assumes that the sensors 102 and 105 primarily capture visual information (e.g., 2D images) of the workspace 101, which may subsequently be used to generate 3D representations of the workspace 101 as described below.

The one or more sensors 105 of robot 103 may be positioned on the robot 103 (e.g., on the tool 104 of the robot 103) to collect image data as the robot 103 moves about the workspace 101. In some embodiments, robot 103 is mobile with multiple degrees of freedom (DOF) and thus sensors 105 positioned on the robot 103 may capture 2D images from a variety of vantage points. In yet other examples, one or more sensors 105 of robot 103 may be stationary while physical structures to be imaged are moved about or within the workspace 101. For instance, a part 106 to be imaged may be positioned on a fixture 108 such as a positioner, and the positioner and/or the part 106 may rotate, translate (e.g., in x-, y-, and/or z-directions), or otherwise move within the workspace 101 while a stationary sensor 105 captures multiple 2D images of various facets of the part 106.

Referring still to FIG. 1, the robot 103, including tool 104, is configured to move within the workspace 101 according to a path plan received from the controller 112 as described below. The robot 103 is further configured to perform one or more suitable manufacturing processes (e.g., welding operations) on the part 106 in accordance with instructions received from the controller 112. In some embodiments, robot 103 employs the tool 104 thereof to perform the one or more suitable manufacturing processes. In some embodiments, the robot 103 can be a six-axis robot with a welding arm. The robot 103 can be any suitable robotic welding equipment such as YASKAWA® robotic arms, ABB® IRB robots, KUKA® robots, and/or the like. The robot 103 can be configured to perform arc welding, resistance welding, spot welding, tungsten inert gas (TIG) welding, metal active gas (MAG) welding, metal inert gas (MIG) welding, laser welding, plasma welding, a combination thereof, and/or the like.

Referring still to FIG. 1, the workspace 101, and specifically the sensors 102 and the robot 103 within the workspace 101, are coupled to the controller 112. The controller 112 is any suitable machine that is specifically and specially configured (e.g., programmed) to perform the actions attributed herein to the controller 112, or, more generally, to the robotic welding system 100. In some embodiments, the controller 112 is not a general-purpose computer and instead is specially programmed and/or hardware-configured to perform the actions attributed herein to the controller 112, or, more generally, to the system 100. In some embodiments, the controller 112 comprises or includes an application-specific integrated circuit (ASIC) configured to perform the actions attributed herein to the controller 112, or, more generally, to the robotic welding system 100. In certain embodiments, the controller 112 includes or is a processor, such as a central processing unit (CPU). In some embodiments, the controller 112 is a field programmable gate array (FPGA). In certain embodiments, the controller 112 includes memory storing executable code, which, when executed by the controller 112, causes the controller 112 to perform one or more of the actions attributed herein to the controller 112, or, more generally, to the robotic welding system 100. Additionally, It may be understood that the controller 112 is not limited to the specific examples described herein.

The controller 112 of robotic welding system 100 controls the sensors 102 and the robot 103 within the workspace 101. In some embodiments, the controller 112 controls the fixture 108 within the workspace 101. For example, the controller 112 may control the sensors 102 to move within the workspace 101 as described above and/or to capture 2D images, audio data, and/or EM data as described above. For example, the controller 112 may control the robot 103 as described herein to perform welding operations and to move within the workspace 101 according to a path planning technique as described below. For instance, the controller 112 may manipulate the fixture 108, such as a positioner (e.g., platform, clamps, etc.), to rotate, translate, or otherwise move one or more parts within the workspace 101.

In some embodiments, controller 112 also controls other aspects of the system 100. For example, the controller 112 may further interact with the UI 110 of robotic welding system 100 by providing a graphical interface on the UI 110 by which a user or operator of system 100 may interact with the system 100 and provide inputs thereto and by which the controller 112 may interact with the user. For instance, controller 112 may provide and/or receive various types of information to and/or from a user (e.g., identified seams that are candidates for welding, possible paths during path planning, welding parameter options or selections, etc.). Additionally, it may be understood that UI 110 may comprise any type of interface, including a touchscreen interface, a voice-activated interface, a keypad interface, a combination thereof, etc.

In this exemplary embodiment, controller 112 interacts with a database 116 of storage 114, for example, by storing data to the database 116 and/or retrieving data from the database 116. Database 116 may more generally be stored in any suitable type of storage 114 that is configured to store any and all types of information. In some embodiments, database 116 is stored in storage 114 such as in the form of a random access memory (RAM), a memory buffer, a hard drive, an erasable programmable read-only memory (EPROM), an electrically erasable read-only memory (EEPROM), a read-only memory (ROM), flash memory, and the like. In some embodiments, the database 116 is stored on a cloud-based platform.

The database 116 may store any information useful to the system 100 in performing welding operations. In some embodiments, database 116 stores a CAD model of the part 106. As certain embodiments, database 116 stores an annotated version of a CAD model of the part 106. In some embodiments, database 116 stores calibration data pertaining to the location and/or pose of one or more components of the workspace 101. For example, the database 116 may store calibration data pertaining to the pose of the tool 104 of the robot 103, such as the global pose of the tool 104 and/or the pose of the tool 104 relative to the one or more sensors 105 of the robot 103. This calibration data stored in database 116 may assist the controller 112 in controlling the operation of the robot 103, such as by accurately and precisely posing the tool 104 as desired relative to another component of the workspace 101 such as the part 106. As one example, the calibration data stored in database 116 may assist the controller 112 in accurately posing the tool 104 in the form of a weldhead relative to a seam of the part 106 to be welded by the weldhead of the robot 103.

Additionally, in some embodiments, the database 116 stores welding instructions generated by the controller 112 and based on the identified pose of the tool 104 relative to one or more sensors of the system 100. For example, the welding instructions may be used to pose, transport, and perform a welding operation on part 106 using the tool 104 of the robot 103. The controller 112 is additionally configured in at least some embodiments to execute a welding operation (e.g., the welding of a seam of the part 106) on the part 106 based on the generated welding instructions and using the tool 104 of the robot 103.

Similarly, welding instructions for the part 106 that are generated based on 3D representations of the part 106, calibration data, and/or on user input provided regarding the part 106 (e.g., regarding which seams of the part 106 to weld, welding parameters, etc.) may be stored in the database 116. In some embodiments, the storage 114 stores executable code 118, which, when executed, causes the controller 112 to perform one or more actions attributed herein to the controller 112, or, more generally, to the robotic welding system 100. In certain embodiments, executable code 118 is a single, self-contained, program, while in other embodiments, the executable code is a program having one or more function calls to other executable code which may be stored in storage 114 or elsewhere. In some embodiments, one or more functions attributed to execution of the executable code 118 may be implemented by hardware. For instance, multiple processors may be useful to perform one or more discrete tasks of the executable code 118.

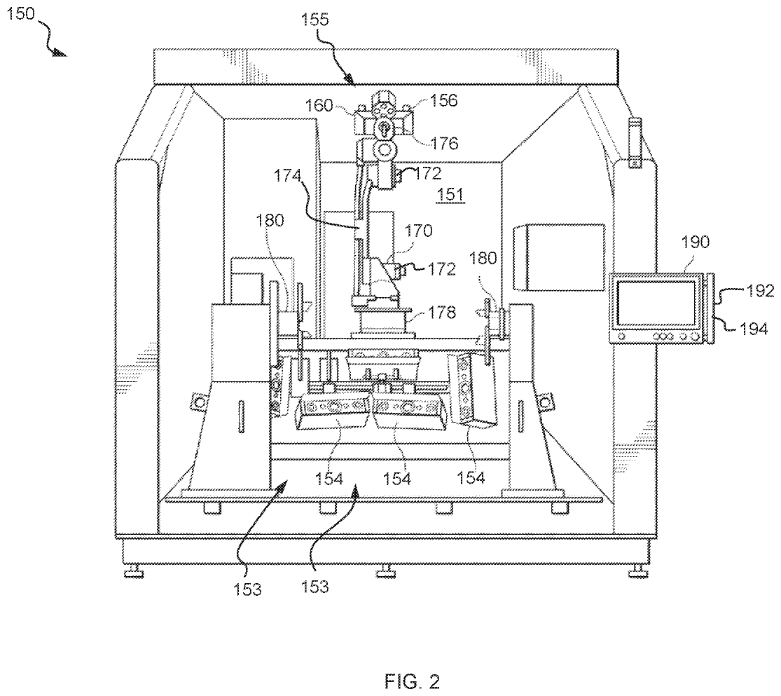

Referring to FIG. 2, another embodiment of a robotic welding system 150 is shown. The robotic welding system 150 comprises but one example of the robotic welding system 100 shown in FIG. 1, with like numerals referring to like components. For example, the system 150 generally includes a workspace 151 comprising a sensor unit 152, a robot 170, and fixtures 180. In this exemplary embodiment, robot 170 includes multiple articulated joints 172 and members or links 174 (e.g., shoulder, arm, elbow, etc.) that enable the robot 170 to move in any suitable number of degrees of freedom. Additionally, robot 170 includes a tool in the form of a weldhead 176 that performs welding operations on a part, for example, a part that may be supported by fixtures 180 (e.g., clamps, platforms). Robotic welding system 150 further includes a UI 190, a controller 192, and storage 194 which may, in some embodiments, be coupled to the workspace 151 while in other embodiments the UI 190, controller 192, and/or storage 194 may be located distal the workspace 151.

In this exemplary embodiment, the sensor unit 152 includes a global sensor unit 153 comprising one or more global sensors 154 to monitor the part held by fixtures 180, and a local sensor unit 155 comprising one or more local or tool sensors 156. In this exemplary embodiment, controller 192 of robotic welding system 150 employs global sensors 154 of global sensor unit 153 to monitor the part held by fixtures 180 while the local sensors 156 of local sensor unit 155 monitor the weldhead 176 attached to robot 170. For example, global sensors 154 may monitor a position, orientation, condition, surface features (e.g., a seam to be welded), and/or other phenomena associated with the part and/or fixtures 180. Controller 192 may in turn employ local sensors 156 to monitor a position, orientation, condition, and/or other phenomena associated with the weldhead 176. In this exemplary embodiment, local sensor unit 155 is positioned along the robot 170 in proximity with the weldhead 176 and is thus free to move relative to both the global sensor unit 153 by one or more DOFs (6 DOFs in some embodiments). In this exemplary embodiment, global sensors 154 and/or local sensors 156 comprise optical sensors or cameras (e.g., high frame rate stereo video cameras), laser sensors, positioning sensors, and/or other types of sensors. Additionally, in some embodiments, sensor unit 152 may not include both global sensor unit 153 and local sensor unit 155. Instead, for example, sensor unit 152 may include only the local sensor unit 155 and not the global sensor unit 153.

In some embodiments, controller 192 may operate components of the robotic welding system 150 autonomously in accordance with instructions stored in the storage 194 of system 150. As an example, controller 192 comprises one or more processors or CPUs which may execute instructions stored in the storage 194 whereby the controller 192 may autonomously performs a welding operation on a part held by the fixtures 180 using the robot 170, weldhead 176, and sensor unit 152. Broadly, the controller 192 may autonomously determine a pose of a part to be welded held by the fixtures 180 using the global sensors 154 of sensor unit 152. Controller 192 may also particularly autonomously identify a seam of the part to be welded using the global sensors 154 of sensor unit 152. Controller 192 may operate the robot 170, weldhead 176, and/or fixtures 180 to weld the identified seam using both global sensors 154 and local sensors 156 of sensor unit 152.

Additionally, the controller 192 of robotic welding system 150 may operate the robot 170, weldhead 176, and/or fixtures 180 based on command inputs provided to the controller 192 by an operator of robotic welding system 150 using the I/O 190 of robotic welding system 150. For example, the operator of robotic welding system 150 may input a command to the I/O 190 to initiate a desired operational sequence executable by the controller 192 to weld or otherwise operate on a part held by the fixtures 180 of the robotic welding system 150. In this exemplary embodiment, I/O 190 comprises a display and an input (e.g., a keypad or other input) 124 from which an operator may both input command signals to the controller 192 and monitor an operational status of the robotic welding system 150. In some embodiments, the operator of robotic welding system 150 may directly control the operation of components of robotic welding system 150 including, for example, robot 170, weldhead 176, sensor unit 152, and/or fixtures 180.

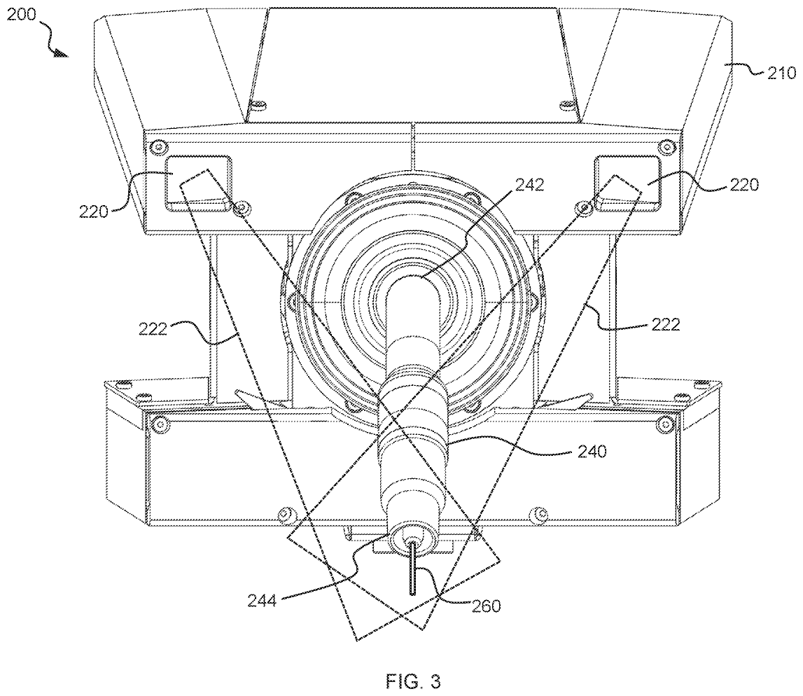

Referring to FIG. 3, an embodiment of a sensor unit 200 of a robotic welding system (e.g., robotic welding systems 10 and 150 shown in FIGS. 1 and 2, respectively) is shown. In this exemplary embodiment, sensor unit 200 comprises a local sensor unit positionable along a robot (e.g., robots 103 and 170 shown in FIGS. 1 and 2, respectively) of a robotic welding system whereby the local sensor unit is moveable in concert with the robot 170 relative to fixtures of the robotic welding system. Thus, sensor unit 200 is also referred to herein as local sensor unit 200; however, it may be understood that in other embodiments, sensor unit 200 may comprise a global sensor unit and/or other types of sensor units. It may also be understood that local sensor unit 155 of the sensor unit 152 briefly described above may be configured similarly as the local sensor unit 200 described below.

In this exemplary embodiment, local sensor unit 200 generally includes a housing 210, and a pair of cameras 220 each received or positioned in the housing 210. It may be understood that local sensor unit 200 may include sensors in addition to the pair of cameras 220 such as, for example, one or more laser scanners not shown in FIG. 3. The housing 210 of local sensor unit 200 couples to a tool or weldhead 240 that extends along a central or longitudinal axis from a first end or base 242 to a second end or tip 244 longitudinally opposite the base 242. The base 242 of weldhead 240 is configured to connect to the terminal end of a robot (e.g., robots 103 and 170 shown in FIGS. 1 and 2, respectively) such that robot may pose the weldhead 240 as desired relative to a part to be welded on by the weldhead 240. Additionally, the tip 244 of weldhead 240 may comprise an electrode, a nozzle, and/or other equipment for welding a part including, for example, performing a seam weld on the part. In this exemplary embodiment, a consumable electrode or welding wire 260 extends longitudinally from the tip 244 of weldhead 240. It may be understood that weldhead 240 may be operated to fuse at least a portion of the welding wire 260 (e.g., filler material or the welding wire 260) to the base material or metal of a part to be welded by the weldhead 240, such as along a seam of the part.

The pair of cameras 220 are positioned in the housing 210 of local sensor unit 200 in a stereoscopic arrangement whereby at least a portion of the weldhead 240 and welding wire 260 are located in a field of view (FOV) 222 of each camera 220. In some embodiments, cameras 220 comprise high-frame rate video cameras; however, it may be understood that the configuration of cameras 220 may vary depending upon the requirements of the given application. In some embodiments, cameras 220 are configured to provide area-scan images rather than line-scan images. In certain embodiments, cameras 220 are configured to sense or detect visible light; however, in other embodiments, cameras 220 may be configured to detect electromagnetic radiation that falls outside of the visible spectrum. Additionally, in certain embodiments, each camera 220 may comprise an acA1440-220um camera provided by Basler AG (Ahrensburg, Germany). The housing 210 of local sensor unit 200 protects or shields the pair of cameras 220 received thereof from the harsh conditions (e.g., heat, weld splatter, etc.) present within the proximity of weldhead 240 during the performance of a welding operation by the weldhead 240. However, it may be understood that in other embodiments the pair of cameras 220 may be arranged differently from the arrangement shown in FIG. 3. For example, in some embodiments, a local sensor unit comprising the pair of cameras 220 may not include a housing in which the pair of cameras 220 are received such as the housing 210 of local sensor unit 200.

The local sensor unit 200 shown in FIG. 3 may be employed by a controller of a robotic welding system (e.g., controllers 112 and 192 shown in FIGS. 1 and 2, respectively) to perform a TCP calibration process calibrating the pose of the tip 244 of the weldhead 240 relative to the pose of the pair of cameras 220 of the local sensor unit 200 where the tip 244 of weldhead 240 corresponds to the “active” point of the tool or weldhead 240 which may be alternatively expressed as the TCP of the robotic welding system incorporating the local sensor unit 200 and weldhead 240. The TCP calibration process performed using the local sensor unit 200 permits the robotic welding system to accurately and precisely pose the tip 244 of the weldhead 240 in 3D space such as in proximity to a seam of a part to be welded by the robotic welding system. It may be understood that precisely and accurately posing the tip 244 of the weldhead 240 in relation to the part to be welded is critical for ensuring satisfactory performance from the robotic welding system in welding the given part.

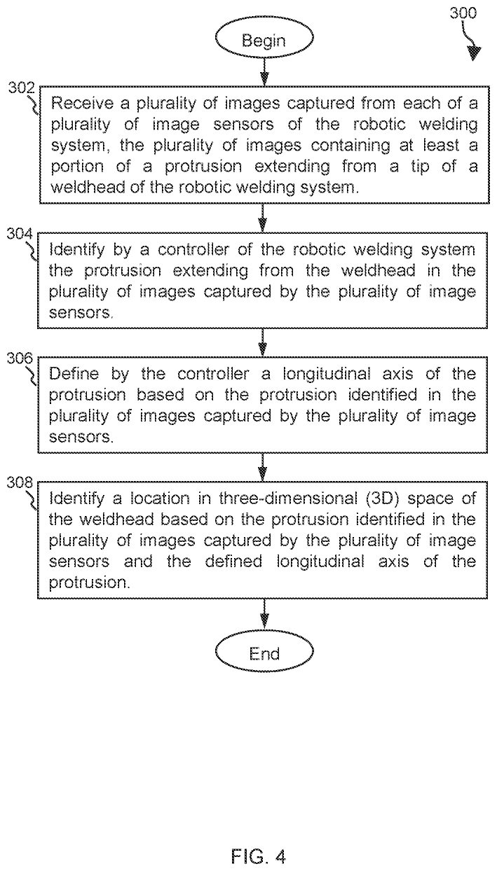

Referring now to FIG. 4, a method 300 for calibrating the TCP of a robotic welding system is shown. It may be understood that method 300 may be performed using any of the embodiments of robotic welding systems (e.g., robotic welding systems 100 and 150 shown in FIGS. 1 and 2, respectively) and sensor units (e.g., sensor unit 152 and local sensor unit 200 shown in FIGS. 2 and 3, respectively) described herein, as well as embodiments of robotic welding systems and sensor units not explicitly described herein.

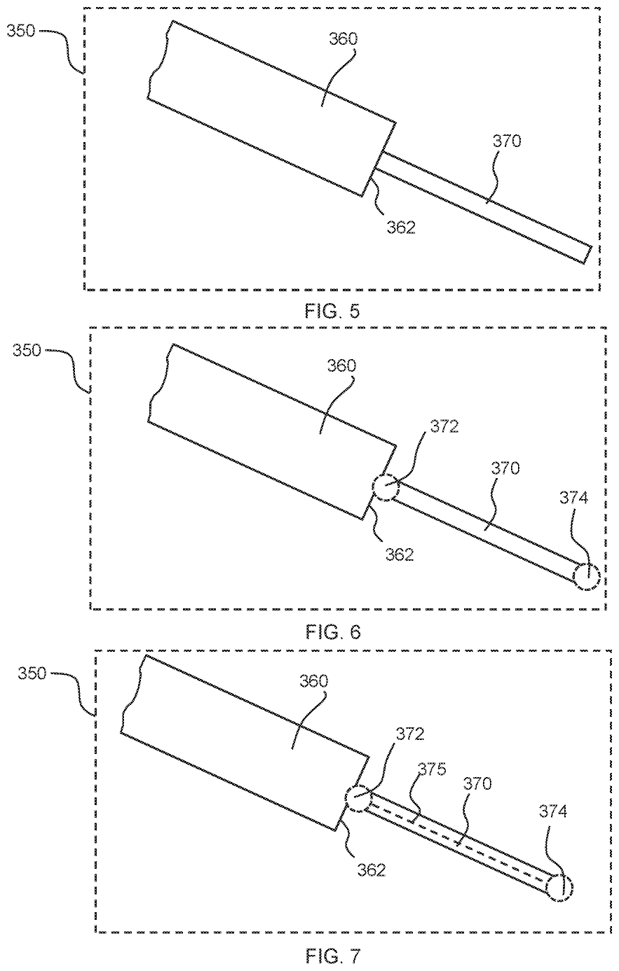

Initially, at block 302 method 300 comprises receiving images captured from a plurality of image sensors of the robotic welding system, the images containing at least a portion of a protrusion extending from a tip of a weldhead of the robotic welding system. As an example, and referring briefly to FIG. 5, an exemplary image 350 is shown captured by an image sensor (e.g., the cameras 220 of local sensor unit 200 shown in FIG. 3). Image 350 of FIG. 5 contains at least a portion of a protrusion 370 extending from a tip 362 of a weldhead 360 of a robotic welding system, such as, for example, a robotic welding system configured similarly as the robotic welding systems 100 and 150 shown in FIGS. 2 and 3, respectively. It may be understood that the image 350 is only exemplary and the perspective of the protrusion 370 captured by the image 350 may vary in other embodiments. Additionally, in this exemplary embodiment, protrusion 370 comprises an electrode or welding wire which may be similar in configuration to the welding wire 260 shown in FIG. 3; however, it may be understood that in other embodiments protrusion 370 may comprise protrusions other than electrodes or welding wires such as, for example cutting elements (e.g., laser cutters), manipulators (e.g., picking manipulators), and grinders. In still other embodiments, weldhead 360 may not include a protrusion at all and instead the calibration may be performed using the weldhead 360 itself.

Returning to FIG. 4, In some embodiments, the plurality of image sensors comprises a pair of stereoscopically arranged cameras. In some embodiments, block 302 comprises receiving images captured from each of the pair of cameras 220 of the local sensor unit 200 shown in FIG. 3, the captured images containing at least a portion of the welding wire 260 extending from the tip 244 of the weldhead 240 shown in FIG. 3. In certain embodiments, block 302 comprises receiving images captured from the sensor unit 152 of the robotic welding system 150 shown in FIG. 2, such as from the global sensors 154 of the global sensor unit 153 and/or the local sensors 156 of the local sensor unit 155. In certain embodiments, block 302 comprises receiving images captured from the sensors 102 and/or the sensors 105 of the robotic welding system 100 shown in FIG. 1.

At block 304, method 300 comprises identifying by a controller of the robotic welding system the protrusion extending from the weldhead in the images captured by the plurality of image sensors. In certain embodiments, block 304 comprises identifying by the controller 112 of the robotic welding system 100 shown in FIG. 2 the protrusion extending from the weldhead in the images captured by the plurality of image sensors (e.g., sensors 102 and/or 105 of robotic welding system 100). In some embodiments, block 304 comprises identifying by the controller 192 of the robotic welding system 150 shown in FIG. 3 the welding wire 260 extending from the weldhead 240 in the images captured by the plurality of image sensors (e.g., the cameras 220 of the local sensor unit 200 shown in FIG. 3).

In some embodiments, block 304 comprises annotating at least one of the images captured by the plurality of image sensors to identify one or more specific features of the protrusion. For example, and referring briefly to FIG. 6, the image 350 of FIG. 5 may be annotated to identify one or more features of the protrusion 370 captured in image 350. Specifically, in this exemplary embodiment, the image 350 is annotated to identify both a base 372 of the protrusion 370 and a tip 374 of the protrusion 370 that is longitudinally opposite or opposed the base 372, as indicated in FIG. 6. It may be understood that features of the protrusion 370 alternative to the base 372 and/or tip 374 may be annotated in other embodiments such as, for example, a midpoint of the protrusion 370.

In certain embodiments, the annotation of the base 372 and tip 374 of the protrusion 370 captured in image 350 is performed manually by a user through a UI (e.g., UI 110 and UI 190 shown in FIGS. 1 and 2, respectively). In other embodiments, the annotation of the base 372 and tip 374 of the protrusion 370 captured in image 350 is performed automatically such as by the controller of the robotic welding system. For example, the controller may execute one or more machine learning (ML) algorithms specifically trained (e.g., via separate training data) to identify one or more specific features of the protrusion 370 such as the base 372 and/or the tip 374 thereof. In some embodiments, an artificial neural network such as a convolutional neural network (e.g., the U-Net convolutional neural network or other neural networks configured for image segmentation, digital image processing, and/or computer vision) may be employed by the controller to automatically identify and annotate one or more features of the protrusion 370 such as the base 372 and/or tip 374 thereof.

At block 306, method 300 comprises identifying by the controller a longitudinal axis of the protrusion based on the protrusion identified in the images captured by the plurality of image sensors. In certain embodiments, block 306 comprises identifying a trajectory of the longitudinal axis of the protrusion in 3D space. In some embodiments, block 306 comprises identifying by the controller 112 of the robotic welding system 100 shown in FIG. 1 or the controller 192 of the robotic welding system 150 shown in FIG. 2 a longitudinal axis of the protrusion based on the protrusion identified in the images captured from the plurality of image sensors (e.g., sensors 102 and/or 105 of system 100 shown in FIG. 1 or the sensors 154 and/or 156 of the system 150 shown in FIG. 2).

Referring briefly to FIG. 7, in certain embodiments, block 306 comprises identifying a longitudinal axis 375 of the protrusion 370 based on the annotated base 372 and tip 374 of the protrusion 370. This may include identifying the trajectory of the longitudinal axis 375 in 3D space. Particularly, the annotated base 372 and tip 374 of the protrusion 370 captured in a first image may define a first plane while the annotated base 372 and tip 374 of the protrusion 370 captured in a second image taken from a different perspective of the protrusion 370 relative to the first image may define a second plane that is separate from the first plane. The first and second planes derived from the first and second images, respectively, intersect along a parameterized line in 3D space identifiable by the controller and which defines the longitudinal axis 375 of the protrusion 370. In this manner, the controller may define the longitudinal axis 375 of the protrusion 370 based on or corresponding to the line of plane-plane intersection formed between the first plane of the first image and the second plane of the second image.

Referring again to FIG. 4, at block 308, method 300 comprises identifying a location in 3D space of the weldhead based on the protrusion identified in the images captured by the plurality of image sensors and the defined longitudinal axis of the protrusion. In some embodiments, block 308 comprises identifying a pose in 3D space of the weldhead based on the protrusion identified in the images captured by the plurality of image sensors and the defined longitudinal axis of the protrusion. In some embodiments, block 308 comprises identifying the pose in 3D space of the tip 244 of the weldhead 240 shown in FIG. 2 in 3D space based on the protrusion 270 identified in the images captured by the plurality of image sensors (e.g., sensors 154 and/or 156 shown in FIG. 2, and cameras 220 shown in FIG. 3).

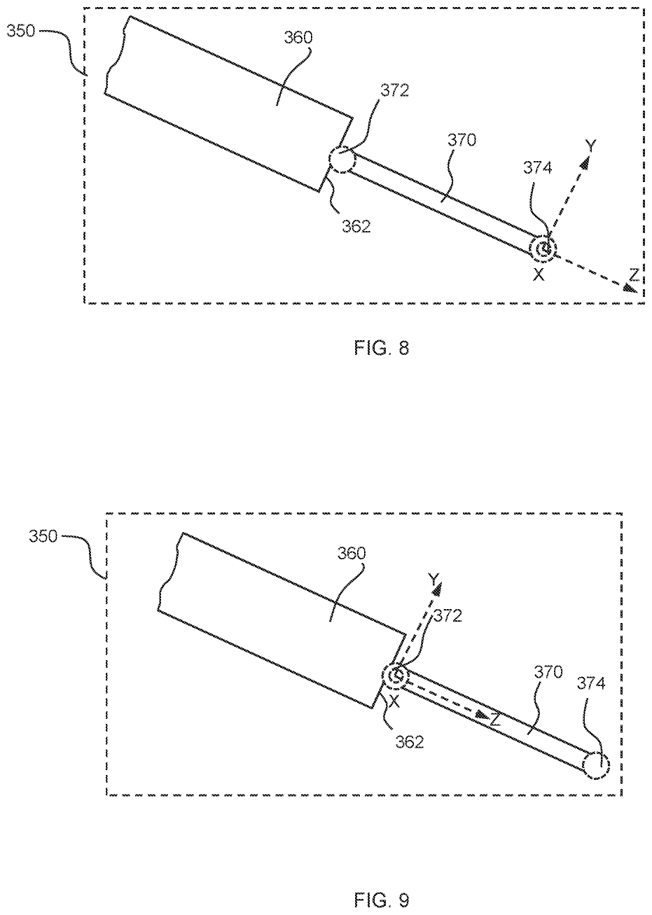

Referring briefly to FIGS. 8 and 9, in some embodiments, block 308 comprises first locating the tip 374 of the protrusion 370 in 3D space based on the protrusion 370 identified in the image 350 captured by the plurality of image sensors and the defined longitudinal axis 375 of the protrusion 370. Once the tip 374 of the protrusion 370 has been located in 3D space, the pose of both the base 372 of the protrusion 370 and the tip 342 of the weldhead 340 (the base 372 of the protrusion 370 and the tip 342 of the weldhead 340 residing at the same location) in 3D space may be located based on the known location of the tip 374 of the protrusion 370 in 3D space, the known length of the protrusion 370, and the known trajectory in 3D space of the longitudinal axis 375. It may be understood that the length of the protrusion 370 is manually provided to the controller by a user of the robotic welding system having knowledge of the length of the protrusion 370 (e.g., via physically measuring the length of the protrusion 370 and/or through other means).

Additionally, in at least some embodiments, the TCP corresponds to an inner or internal nozzle of the weldhead 340 that is spaced from the base 372 of protrusion 370 (e.g., the inner nozzle may be shielded or at least partially covered by an outer or external nozzle of the weldhead 340) along the longitudinal axis 375 of the protrusion 370. In such instances, the location of the TCP (spaced from the base 372) may be determined based located based on the known location of the tip 374 of the protrusion 370 in 3D space, the known length of the protrusion 370 and the known distance between the base 372 and the inner nozzle (or other TCP that is spaced from the base 372 by a known distance), and the known trajectory in 3D space of the longitudinal axis 375.

The pose of the tip 374 of the protrusion 370 and of the tip 342 of the weldhead 340 in 3D space may each be defined by or include three spatial coordinates (e.g., X, Y, and Z coordinates) corresponding to X, Y, and Z mutually orthogonal axes as indicated in FIG. 8 (illustrating the X, Y, and Z coordinates of the tip 374 of protrusion 370 where the Z-axis is extending out of the page in FIG. 8) and FIG. 9 (illustrating the X, Y, and Z coordinates of the base 372 of protrusion 370 where the Z-axis is extending out of the page in FIG. 9). The X, Y, and Z coordinates of the tip 374 of the protrusion 370 and/or of the tip 342 of the weldhead 340 may be global coordinates corresponding to a global X, Y, and Z reference frame. Alternatively, the X, Y, and Z coordinates of the tip 374 of the protrusion 370 and/or of the tip 342 of the weldhead 340 may be local coordinates corresponding to a local X, Y, and Z reference frame. For example, the local reference frame may correspond to a local reference frame associated with the plurality of image sensors (e.g., a local reference frame of the cameras 220 of local sensor unit 200 shown in FIG. 3) whereby the poses of the tip 374 of the protrusion 370 and of the tip 342 of weldhead 340 in 3D space are in relation to the local reference frame associated with the plurality of image sensors.

In some embodiments, the pose of the tip 374 of the protrusion 370 in 3D space may be identified using a stereo-based triangulation algorithm executed by the controller of the robotic welding system (e.g., controllers 112 and 192 shown in FIGS. 1 and 2, respectively). Examples of stereo-based triangulation algorithms executable by the controller to determine the pose of the tip 374 of the protrusion in 3D space include direct linear transformation and/or least squares algorithms. As an example, a first projection of the tip 374 of protrusion 370 may be captured in a first image while a second projection of the tip 374 (different from the first projection) may be captured in a second image having a different perspective from the first image with respect to the protrusion 370. For instance, the first image may be captured by a first image sensor of the plurality of image sensors while the second image is captured by a second image sensor of the plurality of image sensors disposed in a stereoscopic arrangement to the first image sensor with respect to the protrusion 370. The pose of the tip 374 of protrusion 370 in 3D space may be triangulated from the first and second projections of the tip 374 captured in the first and second images, respectively. While this example emphasizes the identification of the pose of the tip 374 of the protrusion 370 and the pose of the tip 342 of weldhead 340 in 3D space, it may be understood that triangulation based on separate projections of an object captured in separate images may be used to determine a pose of objects other than weldhead 340 and protrusion 370 in 3D space. For example, the pose in 3D space of the midpoint of protrusion 370 may be identified using this technique. As another example, the base of the weldhead 340 may be identified using this technique. As a further example, the pose in 3D space of other components of the robotic welding system may be identified using this technique such as, for example one or more nozzles of the weldhead 360 and laser sensors or pointers of the robotic welding system 100.

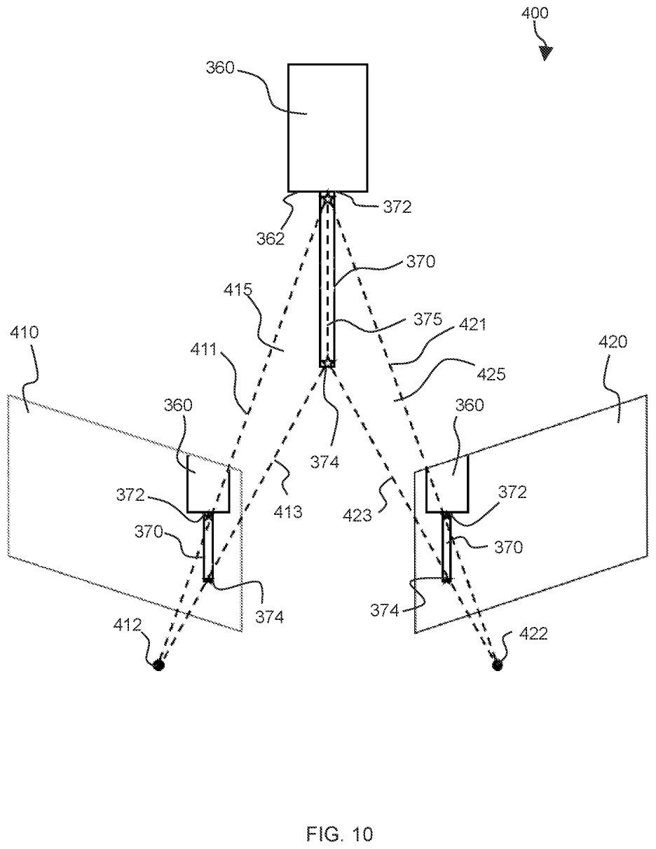

Referring to FIG. 10, a diagram 400 is shown illustrating an exemplary stereo-triangulation technique for determining the pose in 3D space of the protrusion 370 using a pair of cameras (e.g., cameras 220 of local sensor unit 200). Particularly, diagram 400 illustrates the protrusion 370 being captured in both a left image 410 and a right image 420. In this configuration, a first line or vector 411 extends between an optical center 412 of the left camera (not shown in FIG. 10), through the left image 410, and to the annotated base 372 of protrusion 370. Additionally, a second line or vector 413 extends between the optical center 412 of the left camera, through the left image 410, and to the annotated tip 374 of protrusion 370. The two vectors 411 and 413 define a first or left plane 415 extending therebetween and through the left image 410. Similarly, a first line or vector 421 extends between an optical center 422 of the right camera (not shown in FIG. 10), through the right image 420, and to the annotated base 372 of protrusion 370. Additionally, a second line or vector 423 extends between the optical center 422 of the right camera, through the right image 420, and to the annotated tip 374 of protrusion 370. The two vectors 421 and 423 define a second or left plane 425 extending therebetween and through the right image 420. The left plane 415 and right plane 425 intersect along the longitudinal axis 375 of protrusion 370 extending between the annotated base 372 and annotated tip 374, longitudinal axis 375 defining a parameterized line or vector located in 3D space. This parameterized vector defined by longitudinal axis 375 corresponds to the pose of the protrusion 370 in 3D space as determined by the pair of cameras used to produce images 410 and 420.

Once the pose in 3D space of the tip 342 of the weldhead 340 has been identified, the pose of the weldhead 340 and/or of the protrusion 370 in 3D space may be calibrated by the controller of the robotic welding system in relation to the pose of the plurality of image sensors. In this manner, the controller may accurately and precisely identify the pose in 3D space of the weldhead 340/protrusion 370, permitting the controller to accurately and precisely pose in 3D space the weldhead 340/protrusion 370 (corresponding to the TCP of the robotic welding system in this example) relative to a part to be welded such as a seam of the part. Moreover, the technique embodied by method 300 described herein permits the accurate and precise calibration of the TCP of the robotic welding system with minimal manual intervention from a user of the system, thereby minimizing both the time required for performing the TCP calibration and the number of opportunities at which the TCP calibration may go wrong due to user or operator error. Thus, the TCP calibration process embodied by method 300 is both faster and more reliable than the more manually intensive TCP calibration techniques known in the art as outlined above.

Referring again to FIG. 4, in some embodiments, method 300 additionally includes a step for generating welding instructions based on the identified location in 3D space of the weldhead. In certain embodiments, method 300 additionally includes a step for generating welding instructions based on the identified pose in 3D space of the weldhead. The welding instructions may instruct the controller to perform a welding operation on a part using the weldhead, such as the welding of a seam of the part using the weldhead. In certain embodiments, in addition to generating welding instructions, method 300 may further include a step for performing a welding operation on the part using the weldhead, where the performance of the welding operation is controlled or executed by the controller in accordance with the generated welding instructions. While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method for calibrating a tool center point (TCP) of a robotic welding system, the method comprising:
(a) receiving a plurality of images captured from a plurality of image sensors of the robotic welding system, the plurality of images containing at least a portion of a protrusion extending from a tip of a weldhead of the robotic welding system;
(b) identifying by a controller of the robotic welding system the protrusion extending from the weldhead in the plurality of images;
(c) defining by the controller a longitudinal axis of the protrusion based on the protrusion identified in the plurality of images; and
(d) identifying by the controller a location in three-dimensional (3D) space of the weldhead based on the protrusion identified in the plurality of images and the defined longitudinal axis of the protrusion.

2. The method of claim 1, wherein the plurality of image sensors comprises a pair of cameras arranged stereoscopically in relation to the weldhead.

3. The method of claim 1, wherein (c) comprises identifying a trajectory in 3D space of the longitudinal axis of the protrusion.

4. The method of claim 1, wherein the protrusion comprises a welding wire.

5. The method of claim 1, wherein (b) comprises:
(b1) annotating at least one of the plurality of images to indicate a base of the protrusion and a tip of the protrusion located opposite the base of the protrusion identified in the plurality of images.

6. The method of claim 5, wherein (c) comprises:
(c1) defining a first plane in a first image of the plurality of plurality of images based on the annotated base of the protrusion;
(c2) defining a second plane in a second image of the plurality of images based on the annotated tip of the protrusion; and
(c3) intersecting the first plane with the second plane to define the longitudinal axis of the protrusion.

7. The method of claim 1, wherein (d) comprises identifying the location in 3D space of the weldhead based on a first projection of the protrusion captured in a first image of the plurality of images, a second projection of the protrusion captured in a second image of the plurality of images that is different from the first image, and on a known length extending between a base of the protrusion and a tip of the protrusion.

8. The method of claim 1, wherein (d) comprises:
(d1) triangulating a location in 3D space of a tip of the protrusion based on a first projection of a tip of the protrusion captured in a first image of the plurality of images and a second projection of the tip of the protrusion captured in a second image of the plurality of images that is different from the first image; and
(d2) identifying the location of a tip of the weldhead based on the location in 3D space of the tip of the protrusion and on a known length extending between a base of the protrusion and a tip of the protrusion.

9. The method of claim 1, wherein (d) comprises identifying a pose in 3D space of the weldhead.

10. The method of claim 1, wherein the plurality of image sensors comprises at least a portion of a local sensor unit or a global sensor unit of the robotic welding system.

11. A robotic welding system for welding a part, the system comprising:
a fixture for holding the part to be welded;
a robot extending between a base and a terminal end;
a weldhead coupled to the terminal end of the robot, wherein the weldhead receives a protrusion;
a sensor unit comprising a plurality of image sensors arranged whereby at least a portion of the weldhead is within a field of view of each of the plurality of image sensors; and
a controller in signal communication with the sensor unit, wherein the controller is configured to:
receive a plurality of images captured from a plurality of image sensors of the robotic welding system, the plurality of images containing at least a portion of a protrusion extending from a tip of a weldhead of the robotic welding system;
identify the protrusion extending from the weldhead in the plurality of images;
define a longitudinal axis of the protrusion based on the protrusion identified in the plurality of images; and
identify a location in three-dimensional (3D) space of the weldhead based on the protrusion identified in the plurality of images and the defined longitudinal axis of the protrusion.

12. The system of claim 11, wherein the controller is configured to:
annotate at least one of the plurality of images to indicate a base of the protrusion and a tip of the protrusion located opposite the base of the protrusion identified in the plurality of images.

13. The system of claim 12, wherein the controller is configured to:
define a first plane in a first image of the plurality of plurality of images based on the annotated base of the protrusion;
define a second plane in a second image of the plurality of images based on the annotated tip of the protrusion; and
intersect the first plane with the second plane to define the longitudinal axis of the protrusion.

14. The system of claim 11, wherein the controller is configured to:
identify the location in 3D space of the weldhead based on a first projection of the protrusion captured in a first image of the plurality of images, a second projection of the protrusion captured in a second image of the plurality of images that is different from the first image, and on a known length extending between a base of the protrusion and a tip of the protrusion.

15. The system of claim 11, wherein the controller is configured to:
triangulate a location in 3D space of a tip of the protrusion based on a first projection of a tip of the protrusion captured in a first image of the plurality of images and a second projection of the tip of the protrusion captured in a second image of the plurality of images that is different from the first image; and
identify the location of a tip of the weldhead based on the location in 3D space of the tip of the protrusion and on a known length extending between a base of the protrusion and a tip of the protrusion.

16. The system of claim 11, wherein the plurality of image sensors comprises a pair of cameras arranged stereoscopically in relation to the weldhead.

17. The system of claim 11, wherein the controller is configured to:
identify a pose in 3D space of the weldhead based on the protrusion identified in the plurality of images and the defined longitudinal axis of the protrusion.

18. The system of claim 11, wherein the protrusion comprises a welding wire.

19. A system for calibrating a tool center point (TCP) of a robotic welding system, the system comprising:
a processor;
a non-transitory memory; and
an application stored in the non-transitory memory that, when executed by the processor:
receives a plurality of images captured from a plurality of image sensors of the robotic welding system, the plurality of images containing at least a portion of a protrusion extending from a tip of a weldhead of the robotic welding system;
identifies the protrusion extending from the weldhead in the plurality of images;
defines a longitudinal axis of the protrusion based on the protrusion identified in the plurality of images; and
identifies a location in three-dimensional (3D) space of the weldhead based on the protrusion identified in the plurality of images and the defined longitudinal axis of the protrusion.

20. The system of claim 19, wherein the application, when executed by the processor:
annotates at least one of the plurality of images to indicate a base of the protrusion and a tip of the protrusion located opposite the base of the protrusion identified in the plurality of images.

21. The system of claim 20, wherein the application, when executed by the processor:
defines a first plane in a first image of the plurality of plurality of images based on the annotated base of the protrusion;
defines a second plane in a second image of the plurality of images based on the annotated tip of the protrusion; and
intersects the first plane with the second plane to define the longitudinal axis of the protrusion.

22. The system of claim 19, wherein the application, when executed by the processor:
triangulates a location in 3D space of a tip of the protrusion based on a first projection of a tip of the protrusion captured in a first image of the plurality of images and a second projection of the tip of the protrusion captured in a second image of the plurality of images that is different from the first image; and
identifies the location of a tip of the weldhead based on the location in 3D space of the tip of the protrusion and on a known length extending between a base of the protrusion and a tip of the protrusion.

23. The system of claim 19, wherein the application, when executed by the processor:
identifies a location in three-dimensional (3D) space of the weldhead based on the protrusion identified in the plurality of images and the defined longitudinal axis of the protrusion.
